(19) United States
(12) Patent Application Publication
(10) Pub. No.: US 2020/0389624 A1
(43) Pub. Date: Dec. 10, 2020

(54) MOBILE BASED SECURITY SYSTEM AND METHOD

(71) Applicant: Barend Oberholzer, West Hollywood, CA (US)

(72) Inventor: Barend Oberholzer, West Hollywood, CA (US)

(21) Appl. No.: 16/436,752

(22) Filed: Jun. 10, 2019

(51) Int. Cl. H04N 7/18; H04N 5/272; G06K 9/00; H04N 5/225; G01S 13/86; G01S 13/89; G01S 13/88

(52) U.S. Cl. CPC H04N 7/18; H04N 5/272; G06K 9/00255; G01S 13/887; G01S 13/867; G01S 13/89; H04N 5/2252

(57) ABSTRACT

A threat detection and security surveillance system is disclosed. The system may include a millimeter wave imaging system, a thermal imaging system, a video capturing system, an event detection system, a facial recognition system, a mobile device with an interface and a cloud platform. The system may include system devices that may include one or more of the systems to provide a fully mobile and untethered threat detection and security surveillance solution.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to mobile sensing devices and systems, including mobile imaging and threat detection devices and systems.

### BACKGROUND OF THE INVENTION

Conventional security systems include devices such as metal detectors and X-ray systems. Metal detectors can only detect metal objects such as knives and handguns. In addition, such devices cannot discriminate between innocuous items such as glasses, belt buckles, keys, and so forth, and are generally limited in detecting modem threats posed by plastics, ceramic handguns, knives and even more dangerous items such as plastic and liquid explosives.

Other endeavors in this area of interest exist but are limited. For example, a U.S. Pat. No. 6,998,617B2 issued to Advent Intermodal Solutions LLC discloses an apparatus and method for detecting weapons of mass destruction. The apparatus may have an adjustable length, and system for detecting items, such as weapons of mass destruction, in cargo shipping containers or other types of containers. The apparatus comprises one or more detection means and can be releasably secured to a container handling means, such as a crane spreader bar, a top pick, a top handler, a transtainer and a straddle carrier, bar and/or cargo container. Data from the detection means can be transmitted to a local processing system and/or a central processing system.

U.S. Pat. No. 6,359,582B1 issued to MacAleese Companies Inc. discloses a weapons detector (12) and method utilizing radar. The system comprises a transmitter (27) for producing an output (14) of frequencies of a set of self-resonant frequencies of weaponry; an antenna (28) directing the transmitter output toward locations potentially having weaponry and collecting backscattered signals (15); a receiver (29) receiving the backscattered signals (15) and operating over a range of the self-resonant frequencies; and a signal processor (30) for detecting the presence of a plurality of the self-resonant frequencies in the backscattered signals (15). Accuracies of greater than 98% can be obtained at distances, preferably between 4-15 yards. The weapons detector (12) is capable of detecting metal and non-metal weapons (16) on a human body (13) in purses, briefcases and under clothing; and discerning weapons (16) from objects such as belt buckles, coins, keys, calculators, cellular phones.

Another example includes U.S. Pat. No. 6,791,487B 1 issued to Honeywell International Inc. In an active mode, a target can be illuminated by a wide-band RF source. A mechanically scanned antenna, together with a highly sensitive wide-band receiver can then collect and process the signals reflected from the target. In a passive mode, the wide-band receiver detects back-body radiation emanating from the target and possesses sufficient resolution to separate different objects. The received signals can then be processed via a computer and displayed on a display unit thereof for further analysis by security personnel.

A weapon management system disclosed by Neal Solomonis provided includes a number of mobile robotic vehicles (MRVs), a number of squads, each squad having a lead MRV and member MRVs, a number of central control systems, a number of reactive control systems, a central planning control configured to control the plurality of central control systems, a behavior-based reactive control configured to control the plurality of reactive control systems, an intermediated control layer configured to control the central planning control and the behavior-based reactive control, a number of hybrid control models configured to communicate with the intermediate control layer, the hybrid control models including a planning driven model and an adaptation model, a number of synthetic control models configured to communicate with the hybrid control models, and a number of synthetic hybrid control models configured based on combinations of the hybrid control models and the synthetic control models.

U.S. Pat. No. 6,720,905B2 issued to Personnel Protection Tech LLC discloses methods and apparatus for early detection and identification of a threat, and alerting against detected threats, such as individuals wearing or carrying explosive materials and/or weapons, e.g., suicide bombers and other terrorists, at a great enough distance to limit loss of life and destruction of property are disclosed. The methods comprise transmitting a signal in the direction of a potential threat, measuring the detected reflected signal, and comparing the signal level with a threshold indicative of a threat. A monitor is employed to display the threat and attributes of the detected signals. The invention further illuminates the susp1c10 us individual(s) with a Laser illuminator/designator and provides information about the distance to the suspicious individual(s).

U.S. Pat. No. 6,469,624BI discloses a non-obtrusive weapon detection system and method used to discriminate between a concealed weapon made of a ferromagnetic material. The system provides a high probability of detection of hand guns and other types of weapons with a low false alarm rate. The detection of the weapon is accomplished by measuring a total electromagnetic field. The total field being the sum of an incident electromagnetic field and an electromagnetic field scattered from the object. The system uses a magnetic field transmitter, which transmits a low intensity electromagnetic signal. The electromagnetic signal illuminates a volume wherein the weapon, called a target, may or may not be carried by a person. The electromagnetic signal is in a form of a sudden step-like change in a constant magnetic field, called a “time-domain” excitation. The waveform or step pulse of the time-domain excitation is called a Heaviside step pulse. The step pulse creates two signals, which are analyzed and digitally processed using a preprogrammed computer. The analyzed information allows an observer to identify the target as being threatening or non-threatening.

However, the systems described in the aforementioned disclosures are limited in their capabilities. For example, the systems are limited in the types of concealed materials that may be detected. In another example, the systems do not include turnkey self-contained mobile untethered solutions. In another example, the systems cannot detect an acoustic event such as gunshots. In another example, the systems are not able to properly communicate the alerts to a wide range of authorities and/or users.

Accordingly, there is a need for threat detection system that addresses the aforementioned disadvantages.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1-3 show aspects of a detection system according to exemplary embodiments hereof;

FIGS. 4-5 show aspects of a millimeter wave imaging system according to exemplary embodiments hereof;

FIGS. 6-9 show aspects of a transmit-receive module according to exemplary embodiments hereof;

FIGS. 10, 10A and 10B show aspects of a thermal imaging system according to exemplary embodiments hereof;

FIG. 11 shows aspects of camera according to exemplary embodiments hereof;

FIG. 12 shows aspects of a data display according to exemplary embodiments hereof;

FIG. 13 shows aspects of a facial recognition system according to exemplary embodiments hereof;

FIG. 14 shows aspects of an acoustic sensor according to exemplary embodiments hereof;

FIGS. 15-16 show aspects of a machine learning method according to exemplary embodiments hereof;

FIG. 17 shows aspects of a threat detection system diagram according to exemplary embodiments hereof;

FIGS. 18-21 show aspects of a device housing according to exemplary embodiments hereof;

FIG. 22 show aspects of a camera within a device housing according to exemplary embodiments hereof;

FIG. 23 shows aspects of a microphone within a housing according to exemplary embodiments hereof;

FIG. 24 shows aspects of a detection system according to exemplary embodiments hereof; and

FIG. 25 depicts aspects of a computing system according to exemplary embodiments hereof.

### DETAILED DESCRIPTION OF THE PREFERRED EMBODIMENTS

A system according to exemplary embodiments of the current invention is described with reference to the figures.

In general, and in some exemplary embodiments hereof, the system may detect a variety of inputs and provide one or more outputs. In some embodiments, the system may include sensors that may detect visible radiation, non-visible radiation, electromagnetic radiation, thermal radiation, acoustic radiation, other types of radiation and any combination thereof. The system may also capture other types of information such as video. In some embodiments, the system may then convert the detected radiation into data that may be processed and output. For the purposes of this specification, the term radiation may be defined as the emission or transmission of energy in the form of waves or particles through space or through a material medium.

In one exemplary embodiment hereof, the system may include a security and threat detection system that may detect the existence of a threat such as a concealed object (e.g., a gun, a knife, explosives, other types of weapons and/or other types of objects) on a person. The system may detect and identify the threat and may alert the proper authorities. In another exemplary embodiment hereof, the system may detect the presence of a particular individual (e.g., a dangerous, wanted, person of interest, etc.), and upon identifying the individual may alert the proper authorities. In another exemplary embodiment, the system may detect an event such as the existence of gunfire, may localize the source of the event and provide real time location information to the proper authorities. It is understood that the examples described above are not limiting and that the system may detect, identify or otherwise sense a multitude of different threats and/or events, and that the scope of the system is not limited in any way by the type(s) of threats or events that the system may detect and/or identify.

In one exemplary embodiment hereof, the system 10 may provide a fully mobile, handheld and untethered turnkey security surveillance and/or threat detection system that may provide Technical Surveillance Countermeasures (TSCM).

A system or framework according to exemplary embodiments hereof is described here with reference to the drawings.

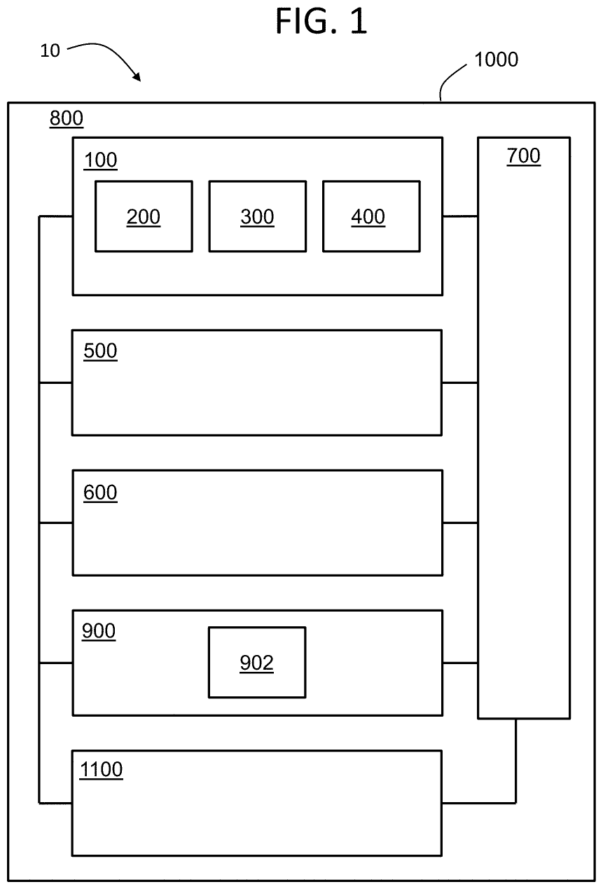

As shown in FIG. 1, in some exemplary embodiments hereof, the system 10 may include a threat detection system that may include the following, without limitation:
1. A detection system 100 that may include, without limitation:
   1A. A millimeter wave imaging system 200;
   1B. A thermal imaging system 300; and
   1C. A video capturing system 400;
2. A facial recognition system 500;
3. An event detection system 600;
4. A processing system 700;
is 5. A system device 800;
6. An integrated mobile device 900 with one or more applications 902;
7. A power and power management system 1100
8. A mobile housing assembly 1000; and
9. Other systems, elements and components as required by the system 10 or otherwise to fulfill its functionalities.

In one exemplary embodiment hereof, the system 10 may include a detection system 100, and the detection system 100 may obtain data from the millimeter wave imaging system 200, the thermal imaging system 300 and/or the video capturing system 400. The data may be obtained from the various systems 200, 300, and 400 simultaneously, sequentially, individually, in any order and in any combination thereof. The system 10 may then process the data using the processing system 700 and may provide the resulting processed data to the user(s) of the system 10.

In one exemplary embodiment hereof, the system 10 may also receive data from its facial recognition system 500 and/or its event detection system 600, and may use the processing system 700 to process the data in combination with the data received by the detection system 100, separately from the data received by the detection system 100, and/or in any combination thereof.

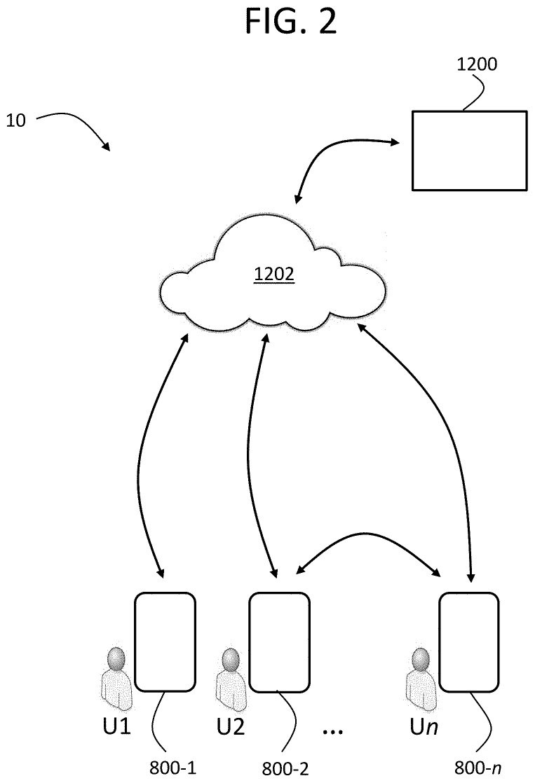

In one exemplary embodiment hereof as shown in FIG. 2, the system 10 may include one or more system devices 800-1, 800-2, . . . 800-n (individually and in combination 800). Each system device 800 may include, without limitation, the detection system 100 (including the millimeter wave imaging system 200, the thermal imaging system 300 and/or the video capturing system 400), the facial recognition system 500, the event detection system 600, at least a portion of the processing system 700, a housing assembly 1000, a power and power management system 1100, and/or other systems, elements and components as required by the system 10 or otherwise to fulfill its functionalities. Note that each system device 800 need not include each of the systems and components listed, and that devices 800 need not match one another regarding the systems and components that the devices 800 may include.

The devices 800 may be mobile system devices 802-1, 802-2, . . . 802-n (individually and collectively 802) (e.g., handheld devices), stationary system devices 804-1, 804-2, . . . 804-n (individually and collectively 804) and any combinations thereof. In this way, the system 10 may include a mobile threat detection system. The devices 800 may be in communication with each other via cellular technology, Bluetooth, wireless, WiFi, any type of network(s), other types of communication protocols and/or technologies, and any combination thereof.

In one exemplary embodiment hereof as shown in FIG. 2, the system 10 may include a cloud platform 1200, and the devices 800 may be in communication with the cloud platform 1200 via a network 1202, such as the Internet, LAN, WAN, wireless, cellular, any other types of networks, other types of communication protocols and/or technologies and any combination thereof.

### Detection System

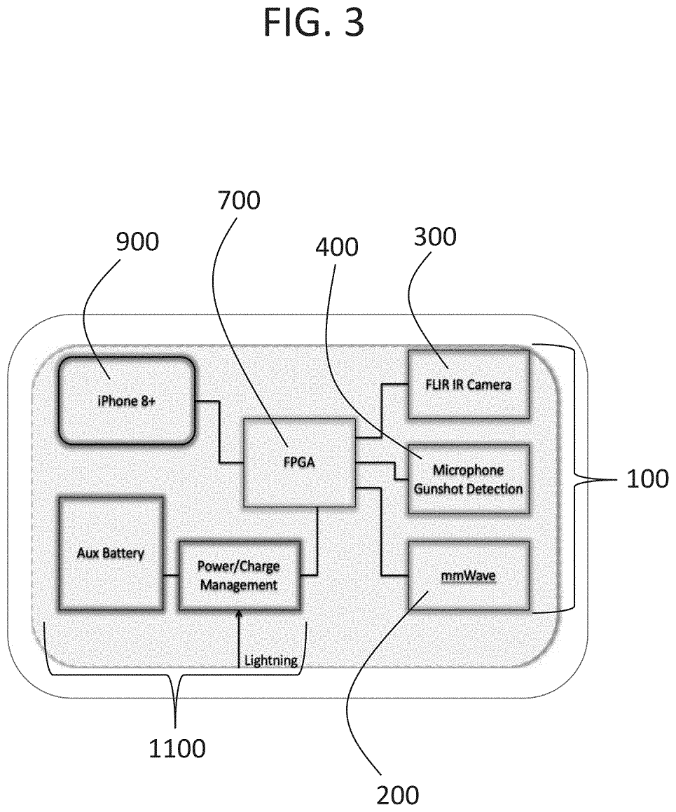

In one exemplary embodiment hereof as shown in FIG. 3, the system 10 may include a detection system 100. The detection system 100 may include, without limitation, a millimeter wave imaging system 200, a thermal imaging system 300 and/or a video capturing system 400. The detection system 100 may detect and identify concealed objects on an individual (e.g., guns, knives, explosives, etc.).

### Millimeter Wave Imaging System

In one exemplary embodiment hereof, the millimeter wave imaging system 200 may include a passive millimeter wave imaging system 202 and/or an active millimeter wave imaging system 204.

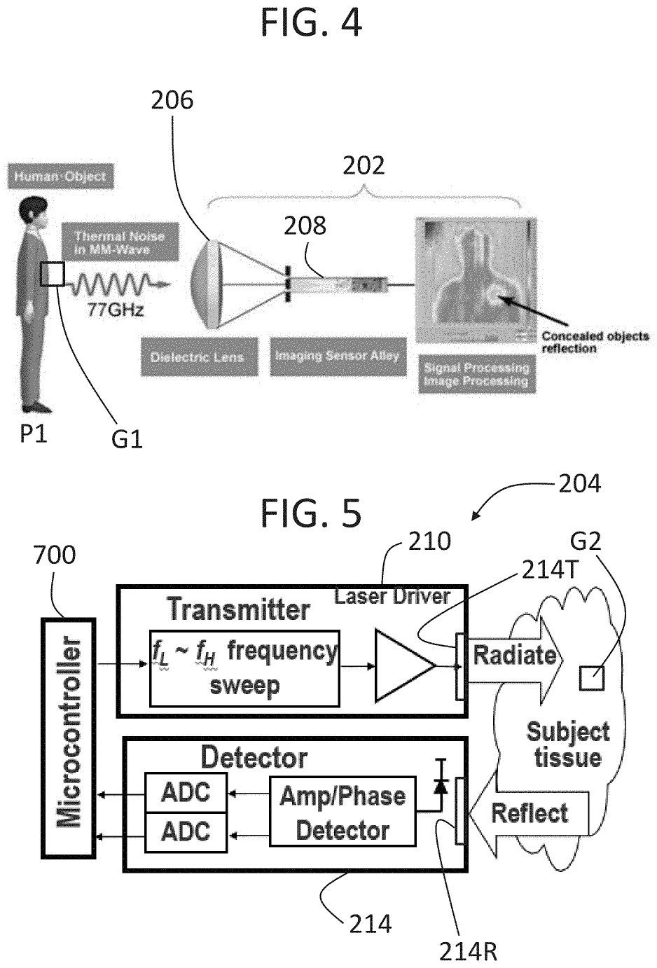

As shown in FIG. 4, the passive millimeter wave imaging system 202 may detect natural radiation that may be emitted from target objects and/or natural radiation from the environment that may be reflected off the target objects. The detected radiation may then be converted into an electronic signal and processed by the processing system 700 to detect and identify the existence of concealed objects (e.g., weapons, explosives, etc.).

The passive millimeter wave imaging system 202 may include a lens assembly 206 and a detector assembly 208. The lens assembly 206 may receive radiation from the target object P1 (e.g., a person of interest, a backpack, etc.) and may focus or otherwise concentrate the radiation onto the detector assembly 208. The detector assembly 208 may then detect the radiation, convert the detected radiation into an electronic data and send it to the processing system 700 for processing. The processing system 700 may process the data to identify the existence of a concealed object G1 on the target object P1 by sensing the contrast (the temperature and/or radiation difference) between the target object P1 and the concealed object G1.

As shown in FIG. 5, the active millimeter wave imaging system 204 may transmit radiation towards the target object and detect the radiation reflected off the target object. The detected radiation may then be converted into an electronic signal and processed by the processing system 700 to detect and identify the existence of concealed objects (e.g., weapons, explosives, etc.).

In one exemplary embodiment, the active imaging system 204 may sense the environment by transmitting, receiving and recording signals from multiple antennas. The broadband recordings from multiple transmit-receive antenna pairs may then be analyzed to reconstruct a three-dimensional image of the environment.

The active millimeter wave imaging system 204 may include a transmitter (TX) 210 and a receiver (RX) 212. The transmitter 210 may transmit radiation directed towards the target object P2 (e.g., a person of interest, a backpack, etc.) and the receiver 214 may receive the resulting reflecting radiation off the target object P2. The data from the receiver 214 may be converted into an electronic signal and sent to the processing system 700 for processing. The processing system 700 may identify the existence of a concealed object G2 on the target object P2 by sensing the contrast (the difference in reflectivity and/or scattering and/or orientation) between the target object P2 and the concealed object G2.

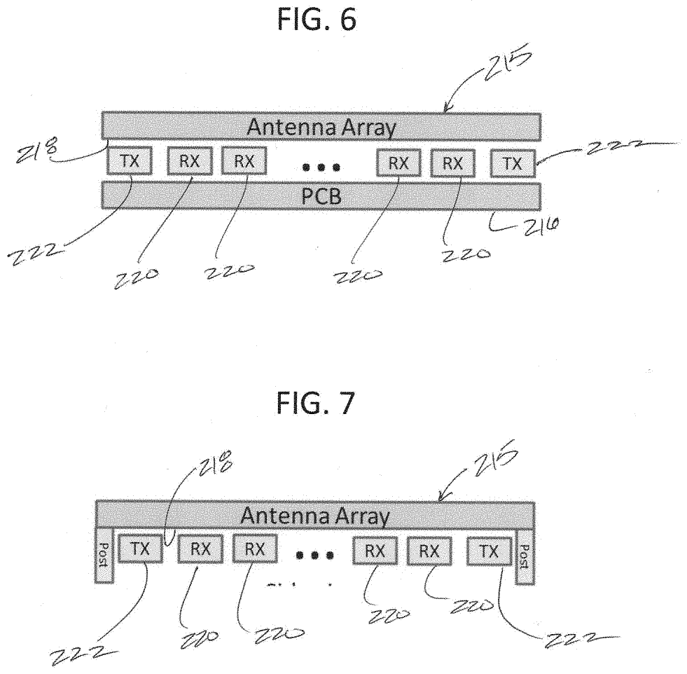

As shown in FIGS. 6-8, the transmitter 210 and receiver 212 may each include one or more antennas 214 (e.g., antenna elements) that may transmit and receive the radiation respectively. In one preferred implementation, the antennas 214 may be formed as an antenna array 215. The transmitter 210 may include transmitter antennas 214T and the receiver 212 may include receiver antenna elements 214R. In one exemplary embodiment hereof as described in other sections, the antennas 214 may be on-board antennas 214.

In one exemplary embodiment hereof, the active millimeter wave imaging system 204 may include an integrated circuit or monolithic integrated circuit (IC). In one embodiment as shown in FIG. 6, the active imaging system 204 may include a printed circuit board (PCB) 216, an antenna array board 218, one or more receiver integrated circuits (RX ICs) 220, and one or more transmitter integrated circuits (TX ICs) 222. The RX ICs 220 and the TX ICs 222 may be mounted on top of the PCB 216, and the antenna array board 218 may be mounted to the RX ICs 220 and TX ICs 222. The antenna elements 214 may be on the top of the antenna board 218 to form the antenna array 215. The PCB 216 may provide signal and power routing to and from the ICs 220, 222, the antenna board 218 and the antenna elements 214. In this way, the PCB 216 may serve as the foundation of the active millimeter wave imaging system 204.

In another exemplary embodiment hereof as shown in FIG. 7, the RX ICs 220 and the TX ICs 222 may be mounted on the underside of the antenna board 218, and the active imaging system 204 may not necessarily include a PCB 216. The antenna elements 214 may be on the top of the antenna board 218 to form the antenna array 215. In this configuration, the signal and power routing between the ICs 220, 222 and the antenna board 218 may be included on the underside of the antenna board 218 and/or in internal layers of the antenna board 218. In this way, the antenna array board 218 may serve as the foundation of the active millimeter wave imaging system 204.

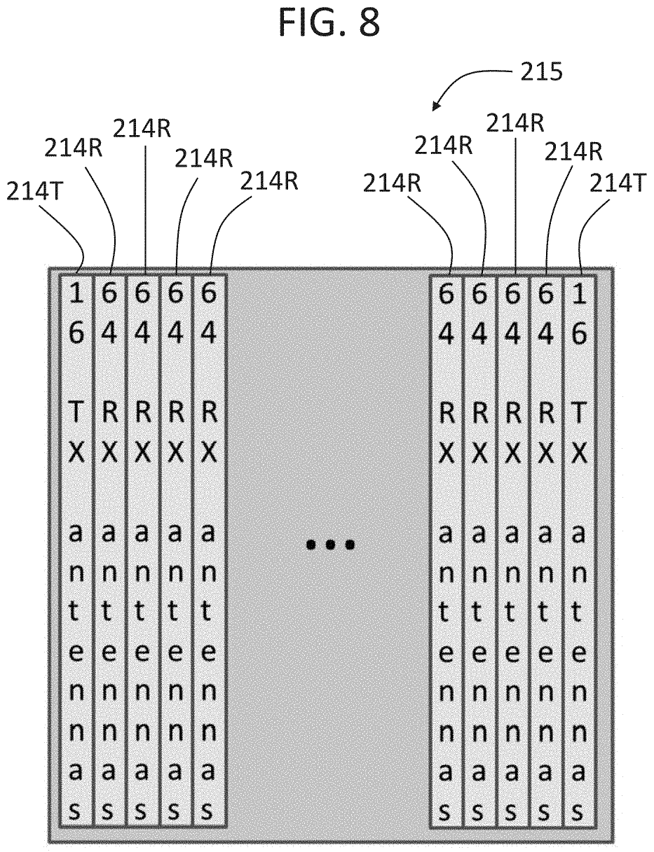

In one preferred implementation of the active millimeter wave imaging system 204 as shown in FIG. 8, the antenna array 215 may include a 64-element by 64-element array of RX antenna elements 214R with a 16-element column of transmitter antenna elements 214T on either side. The minimum spacing between each consecutive antenna element 214 may be λ/2 where λ may be the preferred wavelength of the transmitted and received radiation. It is understood however that the requirements of the antenna elements 214 may dictate a larger and/or smaller spacing which may increase and/or decrease the overall size of the antenna array 215.

In one preferred implementation, each RX antenna element 214R may include one RX circuit element 224, and each RX antenna element 214T may include one TX circuit element 226. It may be preferable that the RX circuit elements 224 be smaller in size than the RX antenna elements 214R, and that the TX circuit element 226 be smaller in size than the TX antenna elements 214T, but this may not be required. The result may be that the RX ICs 220 include 4, 8, or 16 RX circuit elements 224, and that the TX ICs 222 include 4, 8, or 16 TX circuit elements 226. However, it is understood that the actual number of 16 RX circuit elements 224 and TX ICs 222 may depend on the signal routing constraints.

The preferred 64×64 pixel array may thereby include 4096 pixels, and with one RX circuit element 224 for each pixel, the result may include 4096 RX circuit elements 224. One preferred architecture for the receiver 212 may include a low noise amplifier (LNA), a power detector and buffer, and digital control circuitry. The power may be approximately 150 W for 0.18 um SiGe BiCMOS and approximately 20 W for 40 nm SOI CMOS. Note that these approximations are for continuous operation, and it is understood that during operation the system may be turned off while not in use to reduce power. For example, if the system may be turned on for 100 ms during each second, the power may be reduced by a factor of 10. It is understood that the actual power may depend on the duty cycle used.

It is noted that the antenna array 215 may include more RX antenna elements 214R compared to the number of TX antenna elements 214T, and it is understood that the number of elements may depend on the required TX 204 power requirements. In one preferred implementation, the TX 204 may include a voltage-controlled oscillator, a buffer and digital control circuitry. It may be preferable that the number of TX ICs 222 range from two to eight for each system, but other numbers of TX ICs 222 may also be used.

In one exemplary embodiment hereof, the active imaging system 204 may operate at millimeter wave frequencies (e.g., 30 GHz-300 GHz, 70 GHz-120 GHz, etc.). In one preferred implementation, the system 204 may operate at 94 GHz, however, it is understood that the system 204 may operate at other frequencies and/or any combinations of other frequencies.

It may be preferable for the imaging system 200 to scan the target object (e.g., the person of interest) from neck to thigh, and that the distance between the imaging system 200 and the target object be 5m-10m. However, it is understood that the system 200 may scan other areas of the target object from other distances. In one example, a neck-to-thigh target size of four feet with 64-pixel resolution may yield a 0.75-inch effective pixel spacing. The imaging system 200 may detect metallic and non-metallic threats (e.g., explosives, 3D printed guns, etc.).

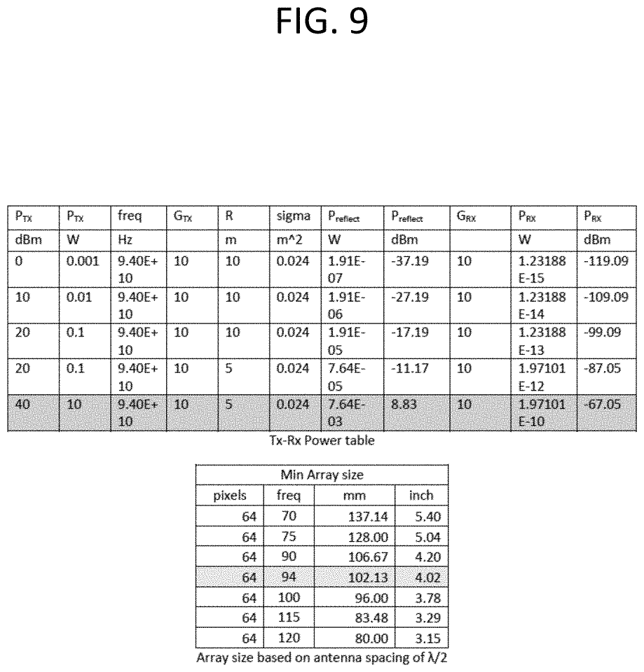

FIG. 9 shows preferred system 200 requirements. It is understood however that the system 200 requirements shown in FIG. 9 are for demonstration purposes and that the system 200 may have other requirements and/or specifications, and that the scope of the system 10 and/or the system 200 is not limited in any way by the requirements shown in FIG. 9.

It is understood by a person of ordinary skill in the art, upon reading this specification, that the examples described above are meant for demonstration purposes and that the passive and/or active millimeter wave imaging systems 202, 204 may include different architectures and different types and numbers of elements. It is also understood that the scope of the system 10 is not limited in any way by the architecture of the millimeter wave imaging system 200 and/or the types of numbers of elements included.

As described above, the millimeter wave imaging system 200 may be included on one or more chips (preferably a single chip), which may allow the imaging system 200 to be included into the mobile devices 802 and/or stationary devices 804. This will be described in other sections.

### Thermal Imaging System

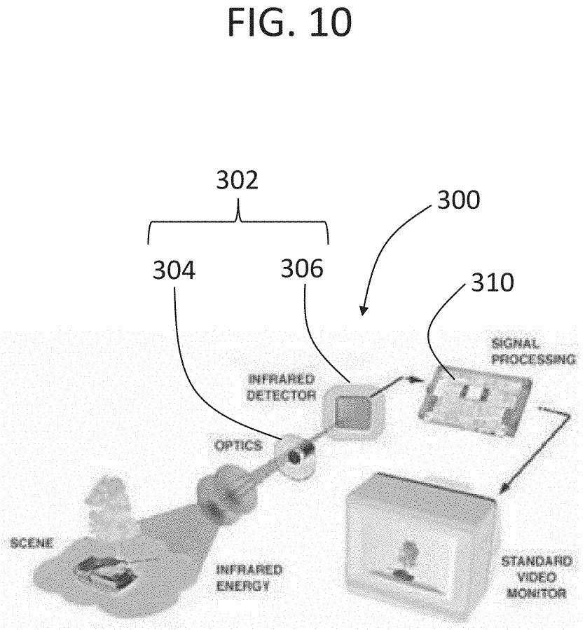

In one exemplary embodiment hereof as shown in FIG. 10, the thermal imaging system 300 may include a camera 302 that may detect energy (e.g., heat), convert the energy to an electronic signal, and then send the electronic data to the processing system 700 for processing. The result may be a thermal image. In one exemplary embodiment hereof, the camera 302 may include an infrared camera 302.

The camera 302 may include a lens assembly 304, a sensor assembly 306 and signal processing electronics 310. In one exemplary embodiment hereof, the lens assembly 304 may include a fixed-focus lens assembly, and the sensor assembly 306 may include a millimeter wave IR (MWIR) detector 306-1 (FIG. 10A) and/or a longwave IR (LWIR) detector 306-2 (FIG. 10B). MWIR detectors may include without limitation photon detectors that may operate at wavelengths of 3-5 microns. LWIR detectors may include without limitation bolometers and/or other types of resistive detectors coupled with one or more amplifiers that may operate at wavelengths of 8-14 microns.

In one preferred implementation, the lens assembly 304 may receive the IR energy emitted by the target object and focus the energy onto the IR sensor assembly 306. The sensor assembly 306 may use the data to create a detailed temperature pattern often referred to as a thermogram. The thermogram data may then be sent to the processing system 700 for data processing. The processing system 700 may then identify thermal patterns on the target object that may represent concealed objects such as concealed gun(s), knives, explosives, and other types of concealed objects. To do so, the thermal detector 306 may output digital counts associated with the radiation or heat that may be absorbed by the detector 306. The counts may then be binned into bands with different colors assigned and associated with each band. The result may be a visual representation of the identified concealed object.

In one preferred implementation, the IR camera may include a LEPTON® LWIR micro thermal camera module manufactured by FLIR®. However, other types of IR cameras may also be used. The infrared camera system may integrate a fixed-focus lens assembly, an 80×60 longwave infrared (LWIR) microbolometer sensor array, and signal-processing electronics. The IR camera module may require a very small footprint, very low power, and instant-on operation. In addition, the module may be operated in its default mode or configured into other modes through a command and control interface (CCI).

It may be preferred that the IR camera 302 include a thermal sensitivity of <50 mK (0.050° C.), a radiometric accuracy (High Gain Mode) of greater of +/−5 degC or 5% (typical), and a intra-scene Range High Gain Mode of −10° C. to 140° C. (typical).

It may be preferable that the thermal imaging system 300 be small, compact and self-contained so that it may be included into the mobile devices 802 and/or the stationary devices 804. This will be described in other sections.

### Video Capturing System

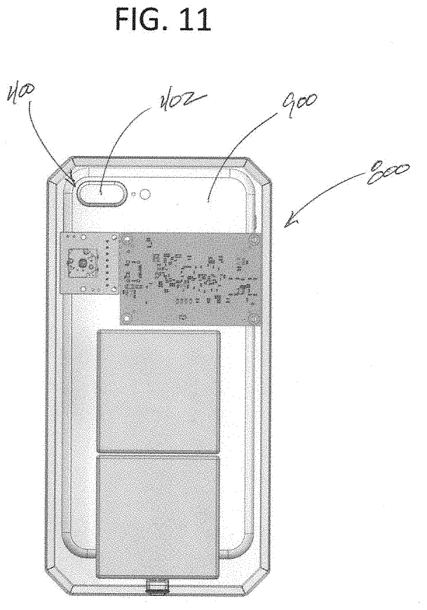

In one exemplary embodiment hereof as shown in FIG. 11, the video capturing system 400 may include a high resolution and/or high definition video camera 402. In one preferred implementation, the video capturing system 400 may include the native video camera of the integrated mobile device 900.

The video capturing system 400 may capture real time video data of the target objects (e.g., the person(s) of interest) in simultaneous orchestration with the capturing of millimeter wave imaging data captured by the millimeter wave imaging system 200 and/or thermal imaging data captured by the thermal imaging system 300. In this way, the video data may be synchronized in real time with the millimeter wave imaging data and/or the thermal imaging data, and the data may be overlaid as described in sections below.

### Data Overlay

In one exemplary embodiment hereof, the detection system 100 and/or the processing system 700 may overlay at least some of the data received by the millimeter wave imaging system 200, the thermal imaging system 300 and/or the video capturing system 400 into a real time image (preferably a moving video stream) of the target object. In this way the data from the different imaging systems 200, 300, 400 may be combined into a live video stream of 3-dimensional data that may clearly show the target object and/or any concealed threats. In one preferred implementation, the system 10 may produce a detailed ten frames per second (10-fps) moving image of the target object with sufficient resolution to reveal concealed objects smaller than two inches on a side. However, other frames per second may also be produced.

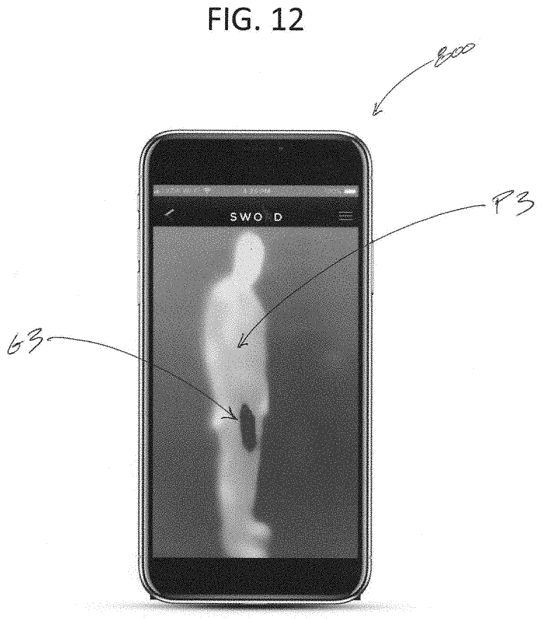

In one example as shown in FIG. 12, the detection system 100 and/or the processing system 700 may overlay the millimeter wave imaging data, the thermal separation imaging data and/or the captured video of a person of interest P3. As shown, the detection system 100 and/or the processing system 700 may show the person of interest P3 and highlight the identified concealed object G3 (in this case a concealed gun). In this way it may not be necessary to view the data from the millimeter wave imaging system 200 directly (thus avoiding possible privacy issues).

In one embodiment of this type, data incoming from the IR camera 302, and the millimeter wave imaging system 200 may be fed (preferably simultaneously) to the FPGA and processed by via its DSP (Digital Signal Processing) blocks that may be designated to perform this task. The processed data may be converted, formatted, overlaid and then package into an IAP2 packet that may be transmitted to and displayed on the integrated mobile device 900 (e.g., an iPhone or other handheld mobile device).

The integrated mobile device 900 may request the IAP2 packet from the FPGA via an app API. Once received, the native RGB camera image stream produced by the integrated mobile device 900 (preferably simultaneously) may be processed and overlaid on top of the incoming IAP2 packet data. The combined data (the overlaid data from the IR camera 302, the millimeter wave imaging system 200 and the integrated mobile device 900) may then be converted to a camera image and subsequently displayed on the integrated mobile device 900 (e.g., on its touchscreen display).

### Facial Recognition System

In one exemplary embodiment hereof as shown in FIG. 1, the system 10 may include a facial recognition system 500. The system 500 may include a camera (such as the native video camera 402 of the integrated mobile device 900 to capture images of the face of the person of interest, and then to recognize or otherwise identify the identity of the person. The system may use biometrics to map facial features from the captured facial image and then compare the information with a database of known faces to find a match.

In one example, the system 500 may perform one or more acts, including without limitation:
1. Detect, track and score facial images from live video or images;
2. Create biometric templates of the best images of faces for comparison to known faces;
3. Compare the biometric template(s) to known faces within one or more databases (in the cloud or otherwise); and
4. Find a positive match and alert the appropriate authorities.

In one exemplary embodiment hereof, the system 10 may implement machine learning (e.g., a machine learning kit library) to detect a face and produce face coordinates for cropping. In this way, they system may create a facial image. The system 10 may then score the detected faces and select the facial images that may include the best resolution. These images may then be sent to the cloud platform 1200 for face recognition. In one preferred implementation, the cloud platform 1200 may include FaceFirst®. The cropped face (preferably about ˜100 klb in file size) may be sent to the cloud platform for conversion to a biometric template and the image may be matched (e.g., the identity of the facial image may be identified). The identified face information may then be sent back to system 10 and displayed or otherwise sent to the proper authorities. It may be preferable that this entire process take about <1 second.

In one preferred implementation, the facial recognition system 500 may identify the identity of the subject, the gender of the subject, the age of the subject, the ethnicity of the subject, facial characteristics of the subject (e.g., glasses, beard, eye/hair color, eyes open/closed, etc.), and the sentiment and emotional state of the subject (e.g., happy/smiling, sad, angry, nervous, etc.).

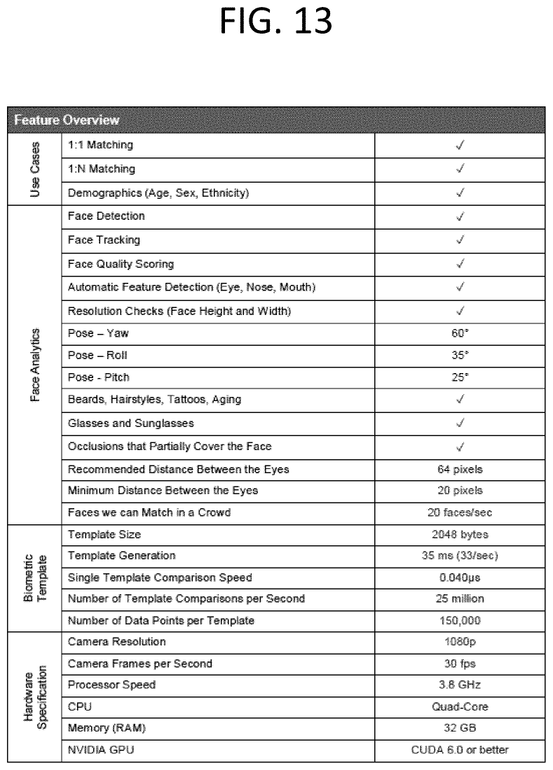

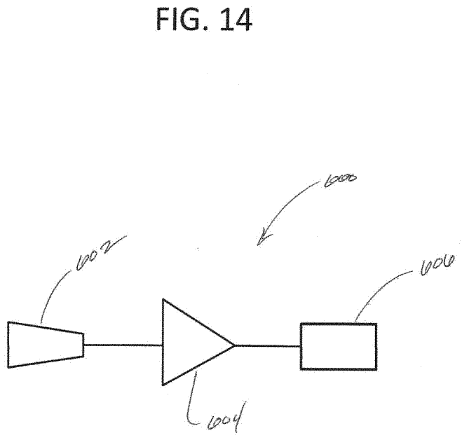

In one preferred implementation, the specifications, aspects and characteristics of the facial recognition system 500 are shown in FIG. 13. However, it is understood that the specifications, aspects and characteristics of the facial recognition system 500 as shown in FIG. 13 are meant for demonstration and that the system 10 and the system 500 may include other specifications, aspects and characteristics, and that the scope of the system 10 and/or the system 500 are not limited in any way by the specifications, aspects and characteristics shown in FIG. 13.

### Event Detection System

In one exemplary embodiment hereof, the system 10 may include an event detection system 600. The event detection system 600 may detect live events such as gunshots, bomb blasts, screams and other types of events.

In one exemplary embodiment hereof as shown in FIG. 14, the event detection system 600 may include a microphone 602, an amplifier 604 and signal processing electronics 606. The microphone 602 may accept analog audio radiation from the ambient surroundings, amplify the signals, digitize the data (e.g., using an analog to digital converter (ADC)), and send the digitized data to the processing system 700 for processing. The processing system 700 may compare the data to known sounds stored within a database to determine if the received acoustic shockwave was created by a specific type of pre-defined event such as a gunshot, a bomb blast, a scream or other types of pre-defined events. Upon identifying a pre-defined event, the system 10 may notify the proper authorities.

In addition, the event detection system 600 may include three or more acoustic sensors to collect enough information (magnitude and phase) to determine the event location (e.g., via location triangulation). In this way, upon determining that the source of the shockwave may match a pre-defined event, the processing system 700 may then determine the location of the event, the distance from the sound source, pattern matching, and other aspects of the event. This information may then be sent to the proper authorities in real time.

In one preferred implementation, the processing system 700 may process the digitized event data using algorithms such as the Sentri gunshot detection algorithm.

The event detection system 600 and the processing system 700 may create intelligent geographic zones that may include the geo-location details of any protected site with respect to the event such that any sounds from within protected zones or from within vehicles known to be operated by non-threatening entities may not create false alerts. Additionally, non-ballistic events, such as door slams, wind noise, tactical radio transmissions, vehicle traffic, firecrackers, urban activity and other types of sounds from non-threatening sources may not cause false alerts.

The system 10 may then send the alerts with geo-references threat positions to the proper authorities to coordinate the proper response to the event.

It may be preferable that the event detection system 600 include the accuracy specifications as shown in Table 1 below. However, it is understood that the system 600 may include other accuracies.

TABLE 1

| | | Gunshot | Recognition |
|---|---|---|---|
| Position | Distance | Count | Percentage |
| Sensor | | | |
| Position | | | |
| Stationary | Shooter at | 11 of 11 | 100% |
| | 50 feet | | |
| Stationary | Shooter at | 11 of 11 | 100% |
| | 100 feet | | |
| Stationary | Shooter at | 11 of 11 | 100% |
| | 150 feet | | |

| | |
|---|---|
| Sensor | 100% |
| Speed | |

| | | | |
|---|---|---|---|
| 30 mph | Shooter at | 12 of 12 | 100% |
| | 50 feet | | |
| 30 mph | Shooter at | 12 of 12 | 100% |
| | 100 feet | | |
| 30 mph | Shooter at | 11 of 12 | 91.6% |
| | 150 feet | | |

| | |
|---|---|
| Average | 97.22% |

As shown in Table 2 below, test results from the event detection system 600 demonstrate that the system 600 may detect muzzle blasts and/or shockwaves from supersonic projectiles. The system 600 may automatically detect selected gunshots at ranges out to 800 meters and receive the projectile shockwave at ranges up to 100 meters. In the data shown below, all weapons detected out to ranges of 400 meters. In one preferred implementation, the system 600 may detect and display the origin of incoming hostile gunfire in less than ¼ second.

TABLE 2

| Firearm | | | Barrel | | |
|---|---|---|---|---|---|
| Model | Caliber | Action | Length | [symbol] | Reason for Selecting |
| [symbol] | [symbol] | Auto | [symbol] | | Represents Most Enemy [symbol] |
| [symbol] | [symbol] | Auto | [symbol] | 1-to-15 | Represents [symbol] |
| [symbol] | [symbol] | Bolt | [symbol] | 1-to-10 | [symbol] |
| [symbol] | [symbol] | Bolt | [symbol] | 1-to-10 | Represents [symbol] |
| [symbol] | [symbol] | Bolt | [symbol] | 1-to-12 | Represents [symbol] |
| [symbol] | [symbol] | Auto | [symbol] | 1-to-10 | Represents [symbol] |
| [symbol] | [symbol] | Auto | [symbol] | 1-to-13 | Represents the USA Enhanced Battle Rifle [symbol] |
| [symbol] | [symbol] | Auto | [symbol] | 1-to-7 | Represents M-4 Carbine, [symbol] |
| [symbol] | [symbol] | Auto | [symbol] | 1-to-10 | In use by some Spec Ops Contractors, & Exec/Dignitary Protection |
| [symbol] | [symbol] | Auto | [symbol] | 1-to-7 | Represents [symbol] series Battle Rifle (USN, USMC, USA, [symbol] |
| [symbol] | [symbol] | Bolt | [symbol] | 1-to-10 | Represents [symbol] |
| [symbol] | [symbol] | Bolt | [symbol] | 1-to-10 | Soldier Killed [symbol] in Afghanistan |
| Shotgun | [symbol] | Pump | [symbol] | CYL | Used by Military |
| Hand Gun | [symbol] | Auto | [symbol] | N/A | Used by Military |
| Hand Gun | [symbol] | Auto | [symbol] | N/A | Used in Europe |
| Hand Gun | [symbol] | Auto | [symbol] | N/A | Carried by US Coast Guard, FBI, etc |
| Hand Gun | [symbol] | Auto | [symbol] | N/A | Carried by some [symbol] |

[symbol]

indicates data missing or illegible when filed

### Processing System

In one exemplary embodiment hereof as shown in FIGS. 1 and 3, the system 10 may include a processing system 700. The processing system 700 may include a Field Programmable Gate Arrays (FPGA) or other types of multi-processor, DSP, PCM, microcontrollers, microprocessors or other types of processing circuitry. The FPGA may include semiconductor devices based around a matrix of configurable logic blocks (CLBs) connected via progra able interconnects. It may be preferable that the FPGA be reprogrammed to desired application or functionality requirements after manufacturing. The processing system 700 may also include any amount of memory as required as well as any type(s) and/or combinations of types of electronic circuitry as required.

As described in other sections, data from the various systems 100, 200, 300, 400, 500, 600 may be sent to the data processing system 700 for processing. The processing system 700 may receive the data, process the data, and use the data to identify, classify and otherwise determine the existence any concealed objects. The processing system 700 may overlay the data from the millimeter wave imaging system 200, the thermal imaging system 300 and/or the video capturing system 400 as described above. The processing system 700 may be configured to share data with, receive data from and to generally work in orchestration with the cloud platform 1200 as required.

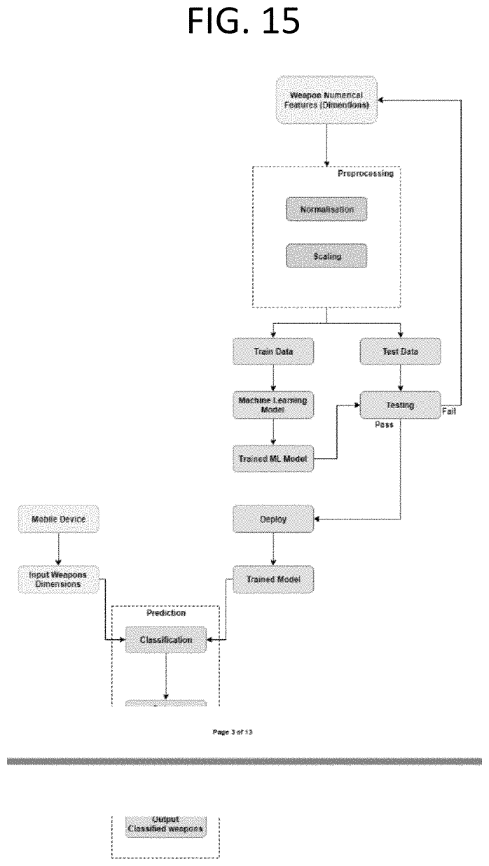

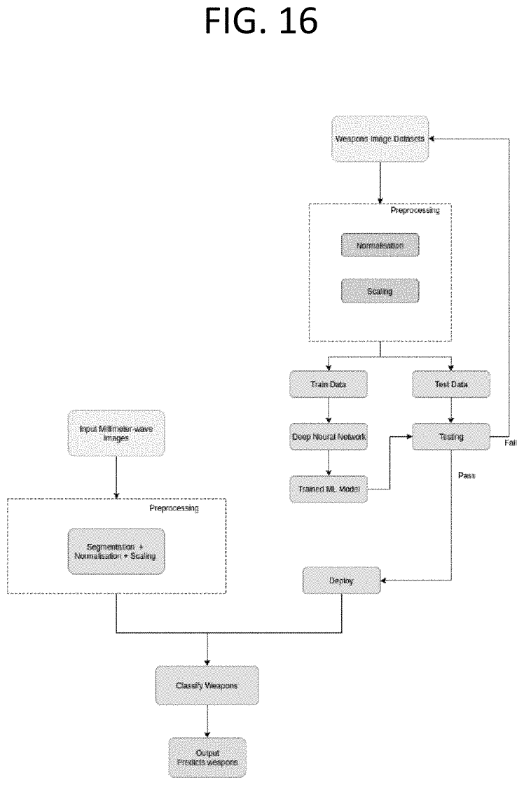

The recognition of the concealed object may be composed of preprocessing the data for magnification, principal component analysis (PCA), size normalization, feature vector extraction, and a decision rule as illustrated in FIGS. 15 and 16. The magnification process may reduce errors that may occur when geometric shape features may be extracted in low resolution binary images.

The system 10 may include machine learning modules and applications that may be trained to detect and identify concealed weapons, such as knives and guns, using data received from the imaging system 100 (including the imaging systems 200, 300 and 400) using deep machine learning. The machine learning modules may be included in the processing system 700, in the cloud platform, elsewhere and in any combination thereof.

The system 10 may include different methodologies of creating the concealed weapon predictive models.

In a first methodology according to exemplary embodiments hereof, the system 10 may use preprocessed weapon datasets that may consist of numeric features (e.g., dimensions, shapes, orientations, etc.) of respective weapons. The system 10 may apply preprocessing techniques to normalize/standardize all the numeric features (mean=0 and standard deviation=1) before applying the data to machine learning techniques. The system 10 may use Standard Scaler or any other algorithm to normalize the features (each column of datasets) so that each column/feature/variable may have a mean=0 and a standard deviation=1.

After preprocessing, the weapon numeric datasets may be placed in training and testing datasets, and the training datasets may be used to train the machine learning model. The system 10 may use classification algorithms such as Random Forests, Support Vector Machine, Decision Tree, etc. to fit and choose the optimal datasets. The result may include a trained model.

After the model has been trained, the test datasets may be used to evaluate the model's performance. The system 10 may use K-fold Cross-validation to create an accurate estimate of the out-of-sample accuracy.

The dimension data produced through the processing of data received by the imaging systems 100, 200, 300, 400 may then be run through the trained model such that the concealed weapon may be classified. The results may then be passed on to the processing system 700 and/or the mobile device 800 as a JSON response.

It may be preferable that the trained model be deployed on the cloud platform 1000, and that an API endpoint may be available on the device 800 to upload the scanned weapon dimensions (and other information) to the cloud 1000. The API and/or the cloud platform 1100 may then run the dimensions (and other information) against the trained model to obtain a prediction of the nature of the concealed object.

In a second methodology, and according to an exemplary embodiment hereof, the system may include deep learning using weapon images as a dataset. In this method, the machine learning model may be trained using a weapon images dataset.

The system 10 may preprocess the weapon datasets using normalization and scaling. Normalization may include the process that may change the range of pixel intensity values so that the mean and standard deviations may be set to a value specified in a predefined range (e.g., [0,1] or [−1, 1]). This may be useful when the system 10 uses data from different formats (or datasets) such that the system 10 may use the same algorithms on all of the data. Image scaling may include the resizing of the weapon images into a common size to reduce the complexity at the timing of feeding the images through a deep neural network.

After preprocessing, the weapons datasets may be placed in training and testing datasets, and the training datasets may be used to train the deep learning model. The system 10 may use a deep learning algorithm such as a convolution neural network (ConvNet/CNN) which may input an image, assign importance (learnable weights and biases) to various aspects/objects in the image, and differentiate one image from another.

The system 10 may then flatten the weapon images into a column vector. The flattened output may then be fed into a feed-forward neural network and back-propagation may be applied to every iteration of training. Over a series of epochs, the model may be able to distinguish various weapons and classify then using classification techniques such as the Softmax classification technique.

After the model has been trained, the test datasets may be used to evaluate the model's performance. The system 10 may use K-fold Cross-validation to create an accurate estimate of the out-of-sample accuracy.

Next, the weapons may be predicted and classified. Data from the imaging systems 100, 200, 300, 400 may be segmented. Segmentation may be used to detect specific objects from an image and create a mask around the object of interest. Based on bounding box coordinates, the system 10 may segment the intended region and perform image processing using OpenCV (or other algorithms) to segment the region of weapons. Next, the system 10 may perform the same or similar preprocessing techniques on weapon images and pass them through the deep learning model. The system 10 may then predict and classify the weapons categories.

It is understood that while the examples above described the machine learning and training model with respect to weapons such as guns and/or knives, it is understood that the system 10 may detect, identify and train the model for other types of objects (such as explosives and other types of objects) using the same or similar method. It is also understood that the scope of the system 10 is not limited in any way by the type of object that the system 10 may detect, classify and use to train the model and/or predict an actual outcome.

### Integrated Mobile Device and Application

In one exemplary embodiment hereof as shown in FIG. 1, the system 10 may include an integrated mobile device 900. The integrated mobile device 900 may preferably be configured with a system device 800 (e.g., a mobile system device 802 and/or a stationary system device 802). In one exemplary embodiment hereof, the integrated mobile device 900 may be physically integrated into the system device 800. That is, the integrated mobile device 900 may be contained, at least partially, within the housing assembly 1000. In one preferable implementation, the integrated mobile device 900 may be completely housed within the housing assembly 1000 in a way that at least a portion of (and preferably all of) the integrated mobile device's native touch screen may be accessible and usable to the user of the system 10. In this way, the user of the system 10 may interface with the system 10 and its assemblies and systems 100, 200, 300, 400, 500, 600, 700, 900, 1100 via the touchscreen. Other control mechanisms of the integrated mobile device 900 (e.g., control buttons, keypad, keys, etc.) may also be accessible to the user and utilized as desired.

The integrated mobile device 900 may include a smart phone (e.g., an iPhone® or other type of smart phone), a tablet computer (e.g., an iPad® or other type of tablet computer), or any other type of mobile device. It may be preferable that the integrated mobile device 900 include a native camera (e.g., for still photographs and/or video capturing), an output device such as a touchscreen, a processor, memory and other elements and components as required by the system 100.

In one exemplary embodiment hereof, the integrated mobile device 900 may include one or more applications 902 (app(s)) that may be used to interface with the systems 100, 200, 300, 400, 500, 600, 700 and the cloud platform 1100. The application may utilize an API to receive data from the systems 100, 200, 300, 400, 500, 600, 700 and the cloud platform 1100 and/or to send data to the systems 100, 200, 300, 400, 500, 600, 700 and the cloud platform 1100. In this way, the integrated mobile device 900 may be used to generally control the system 100 and its functionalities (e.g., to utilize the functionalities of the system 100 and its systems and devices 100, 200, 300, 400, 500, 600, 700 and the cloud platform 1100). The integrated mobile device 900 may interface with, receive data from, send data to, and generally communicate with the processing system 700 (e.g., the FPGA) to process the data as described above.

In one exemplary embodiment hereof, the integrated mobile device 900 may display the processed data and/or any determinations made by the system 10 (e.g., the existence of a concealed weapon, the type and/or classification of any weapon, etc.) on its display in an easy to understand format. In one exemplary embodiment hereof, the integrated mobile device 900 may display the overlaid data from the millimeter wave imaging system 200, the thermal imaging system 300 and the video capturing system 400 as described above and as shown in FIG. 12.

In addition, the user of the system 10 may interface with and/or control the system 10 and its various assemblies and systems 100, 200, 300, 400, 500, 600, 700, 900, 1100 via the interface mechanism (e.g., the touch screen) of the integrated mobile device 900.

It is understood that the integrated mobile device 900 may not necessarily be a mobile device 900 that may initially be separate from the system device 800 (e.g., a smartphone) and then combined with the system device 800 (e.g., by housing the integrated mobile device 900 into the housing 1000), but may also include a device 900 that be configured (and/or designed and/or manufactured) as a portion of the system device 800. It is also understood that the scope of the system 10 is not limited in any way by the type or configuration of the integrated mobile device 900 and the system device 800.

### Power and Power Management System

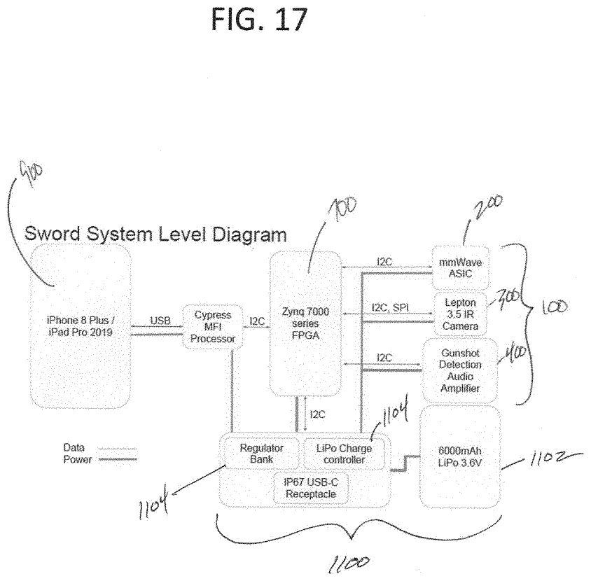

In one exemplary embodiment hereof as shown in FIG. 17, the system 10 may include a power and power management system 1100. The system 1100 may include one or more rechargeable batteries (1102), a charge controller 1104 and a regulator bank 1104.

In one preferred implementation, the rechargeable battery 1102 may include a 4000/Mah LiPo battery. It is understood that any other types of adequate rechargeable devices may also be used.

The power and power management system 1100 may simultaneously provide charging to the integrated mobile device 900 and rechargeable battery 1102, as well as supplying the necessary power to the systems 100, 200, 300, 400, 500, 600, 700, 800 and 900.

### Mobile Housing System

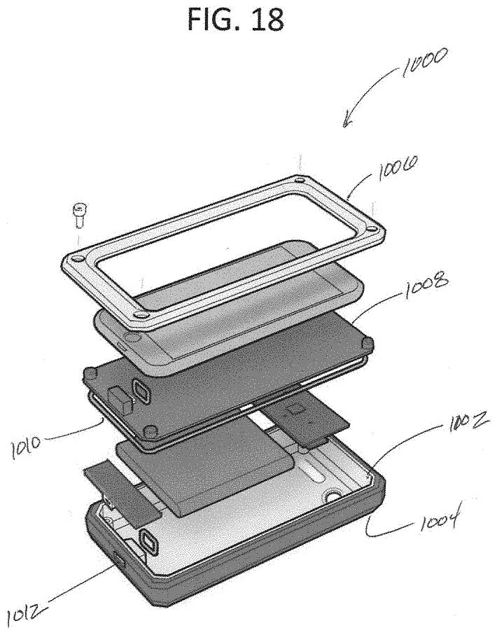

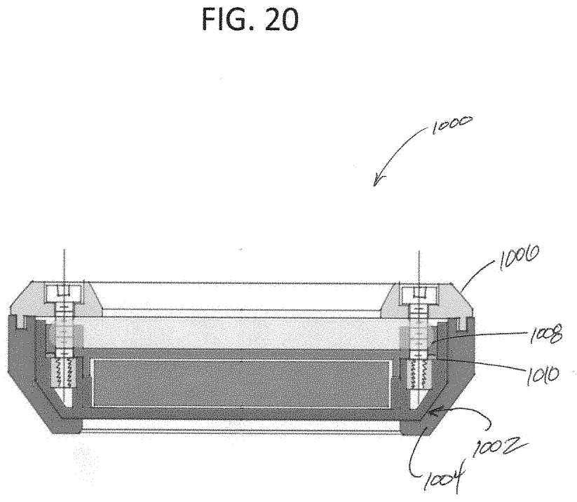

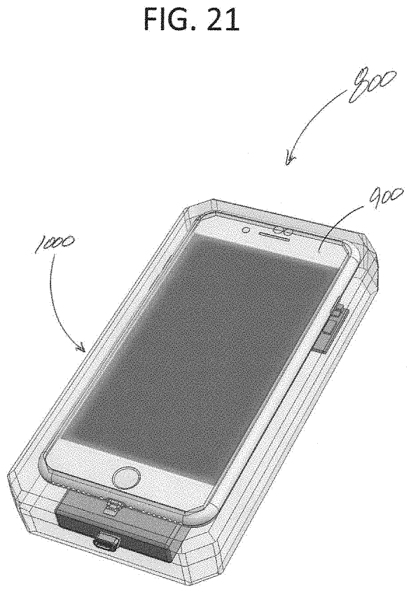

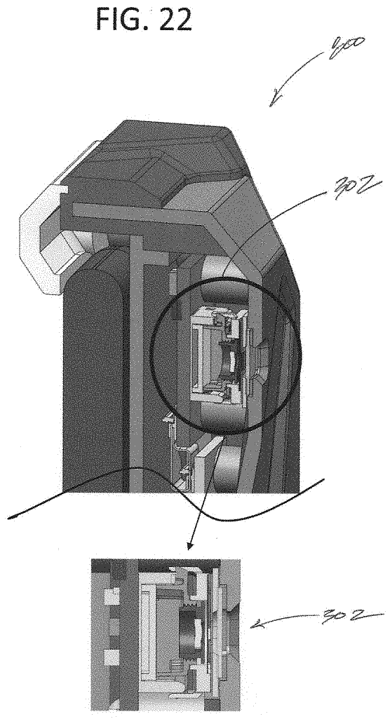

In one exemplary embodiment hereof as shown in FIGS. 1 and 18-21, the system device 800 may include a mobile housing assembly 1000 that may house, contain, protect, enable, encompass, shield and otherwise include the detection system 100 (including the millimeter wave detection system 200, the thermal detection system 300 and/or the video capturing system 400), the facial recognition system 500, the event detection system 600, the processing system 700, the integrated mobile device 900, the power and power management system 1100 and/or any other systems, elements and/or components as required by the system 10. In general, the system 10 as shown in FIG. 1 as well as the other systems and components as described in other sections may be enclosed within the mobile housing assembly 1000.

The housing 1000 may be designed to be handheld (mobile), and may include a bucket 1002 (with or without a perimeter bumper 1004), a faceplate 1006, a bucket lid 1008 (may also function as the integrated mobile device cradle), a perimeter seal 1010, an I/O port 1012 (e.g., a USB-C or Lightening port, etc.), and other components. The housing 1000 may provide a protective enclosure for the integrated mobile device 900, the battery 1102, the FPGA/PCBAs (e.g., the processing system 700), the power management PCBA 1104, etc.).

In one preferred implementation, the housing assembly 1000 may secure at least a portion of (and preferably all of) the systems 100, 200, 300, 400, 500, 600, 700, 900, 1100, and at least a portion of (and preferably all of) the aforementioned systems' elements and components as required. In a preferable embodiment hereof, the housing assembly 1000 may secure all the systems 100, 200, 300, 400, 500, 600, 700, 900, 1100, and all the aforementioned systems' elements and components as required. In this way, the housing 1000 and the systems and components contained within the housing 1000, may embody the mobile handheld security and threat detection system of the system 10.

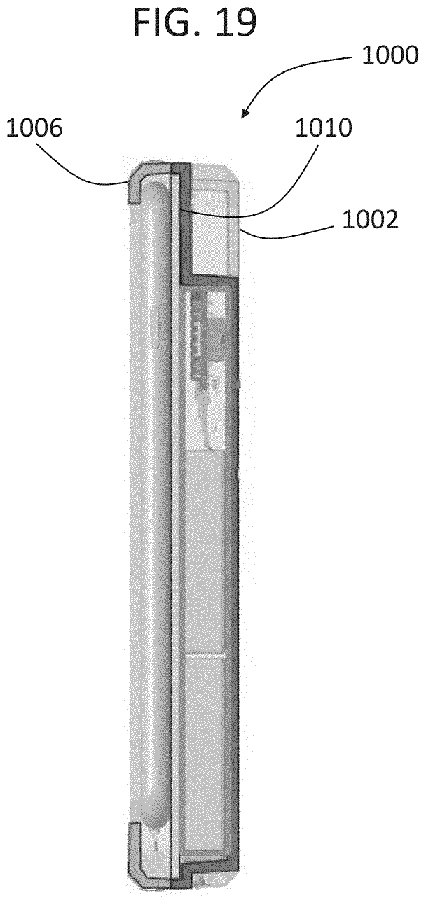

When assembled as shown in FIGS. 19-21, the housing 1000 may provide a water-tight/resistant, shock resistant protective enclosure for the system 10. The housing assembly 1100 may also include an input port for power recharging, data input/output and for other uses. The data port may preferably include a Lightning interface, a USB-C interface, or any other type of I/O interface that may be adequate.

The thermal imaging camera 302 is shown in FIG. 22. It may be preferable that the thermal imaging system camera 302 be positioned in close proximity to the native camera of the integrated mobile device 900, but it is understood that the camera 302 may be positioned in any position and/or orientation within the housing 1100 as required.

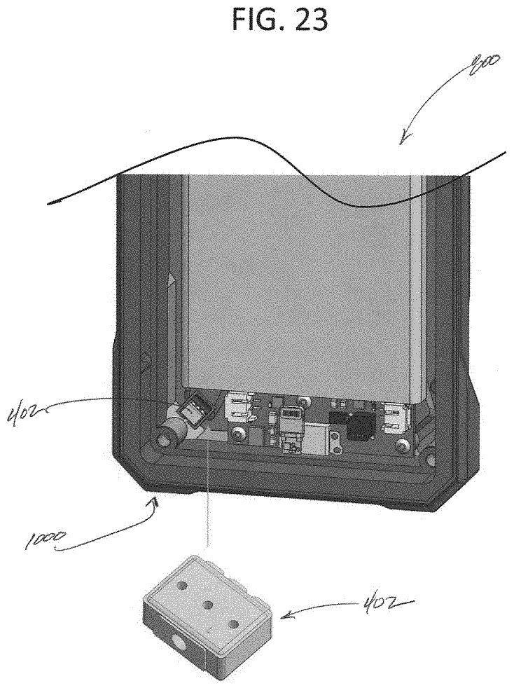

As shown in FIG. 23, it may be preferable that the microphone 402 of the event detection system 400 be positioned in one of the four corners of the housing 1100 (e.g., the lower left corner as shown) but it is understood that the microphone 402 may be positioned in any position and/or orientation within the housing 1100 as required.

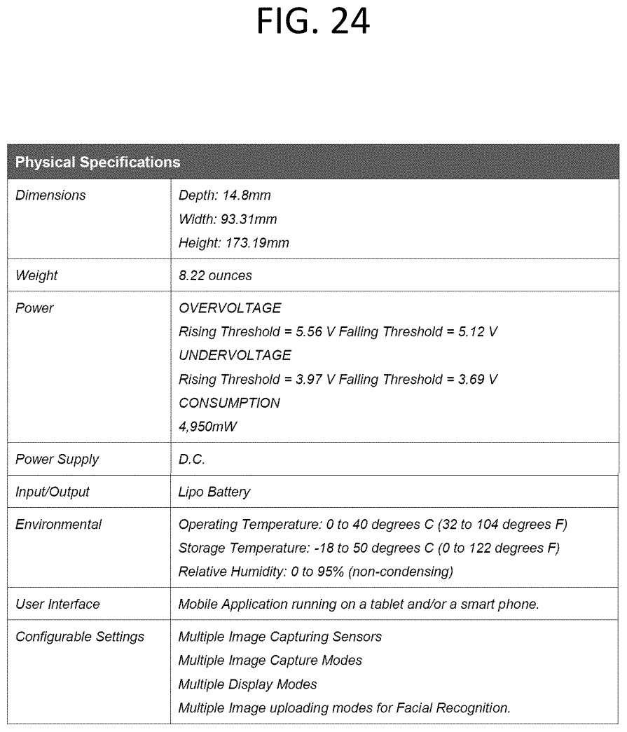

The preferred physical specifications are shown in FIG. 24. However, it is understood that the specifications shown in FIG. 24 are meant for demonstration purposes and that the system 10 may include any physical specifications as necessary. It is also understood that the scope of system 10 is not limited in any way by the specifications shown in FIG. 24.

Additional aspects and/or benefits of the system 10 may include, without limitation:
1. If and when the system 10 may identify a threat (e.g., a concealed weapon, gunshot, a person of interest, etc.), the system may send notifications to one or more system devices 800, the cloud platform 1100 and to any other external recipients (e.g., police authorities) as required. The notifications may also trigger automated systems (of the system 10 or otherwise) to safely gather additional information and implement safety and security protocols.
2. All systems of the system 10 may operate simultaneously in orchestration and/or as individual systems.
3. It may be preferable that each system 100, 200, 300, 400, 500, 600, 700, 800, 900, 1000, be small with a small physical footprint (e.g., preferably provided on one or more IC chips) such that the systems may all fit within the device 800 to provide a fully mobile, handheld and untethered system 10. In this way, the device 800 may provide a turnkey mobile solution for the implementation of the system 10.
4. The system 10 may utilize the touchscreen of the integrated device 900 as an I/O interface, and/or may include additional control mechanisms (e.g., buttons, dials, switches, etc.) as necessary.
5. The system 10 (e.g., the housing 1000) may include mounts or other types of attachment mechanisms that may allow the housing 1000 and the devices 800 to be attached to other structures such as tripods, street light enclosures, drones, etc.).

Those of ordinary skill in the art will appreciate and understand, upon reading this description, that any and/or all of the aspects described in this specification in relation to any of the embodiments hereof may be combined in any way. It is understood that the system 10 may include any and/or all of the aspects and elements of any of the embodiments described. It is also understood that any embodiments hereof may provide different and/or additional advantages, and that not all embodiments or implementations need have all advantages.

### Cloud Platform

In one exemplary embodiment hereof as shown in FIG. 2, the system 10 may include a cloud platform 1200 that may include one or more servers (such as Internet servers) and that may include all of the components (hardware and software) necessary to transmit data to and receive data from one or more system devices 800, and to analyze or otherwise process the data it may receive and/or transmit. For example, the cloud platform 1200 may include a CPU, microprocessor, microcontroller, chipset, control board, RAM, general memory, network boards, power supplies, an operating system, software, applications, scripts and any other component, application, mechanism, device or software as required. The cloud platform 1200 may also receive data from and transmit is data to other devices such as mobile phones, tablet computers, laptops, personal computers and other devices. In this case, it may be preferable for these devices to include an application (e.g., a mobile app) that may facilitate the communication between each device and the cloud platform 1200.

The cloud platform 1200 may generally receive data transmitted to it by the system devices 800 through a network 1202 (e.g., the Internet, LAN, WAN, or other types of networks) for analysis and/or processing. The cloud platform 1200 may also transmit information, commands or other types of data to the system devices 800 that the system 10 may utilize while performing its functionalities. The cloud platform 1200 may preferably communicate with the system devices 800 through an Internet connection (e.g., via a modem through a service provider) that may include a wireless connection such as Wi-Fi via an Internet modem and router, via network cables or transmission lines, through cellular networks or by other means.

The cloud server 1200 may receive data from the system devices 800 (e.g., data from one or more of the systems 100, 200, 300, 400, 500, 600, 900), may store the data in a database or in other types of data filing architectures within its memory, and may analyze the data according to models of operation, criteria, rules or other types of parameter definitions. The cloud platform 1200 may also download data to another platform or facility where the data may be stored, analyzed, or otherwise evaluated, compared to the criteria of each particular model of operation and/or generally processed.

Note that the cloud platform 1200 may receive data from and/or transmit data to one or more system devices 800 at a time, simultaneously and in real time. In this way, a multitude of systems 100, 200, 300, 400, 500, 600, 900 and/or associated system devices 800 may be in communication with one or more cloud platforms 1200 at any time. It may be preferable that each system device 800 and systems 100, 200, 300, 400, 500, 600, 900 have unique identifiers (such as a serial number, IP address or other type of unique identifier) and that the cloud platform 1200 may recognize each unique identifier and communicate with each system device 800 individually. In this way, the cloud platform 1200 may organize and manage the data for each system device 800 and the associated systems 100, 200, 300, 400, 500, 600, 900.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and Understand, upon reading this description, that the various processes described herein may be implemented by, e.g., appropriately programmed general purpose computers, special purpose computers and computing devices. One or more such computers or computing devices may be referred to as a computer system.

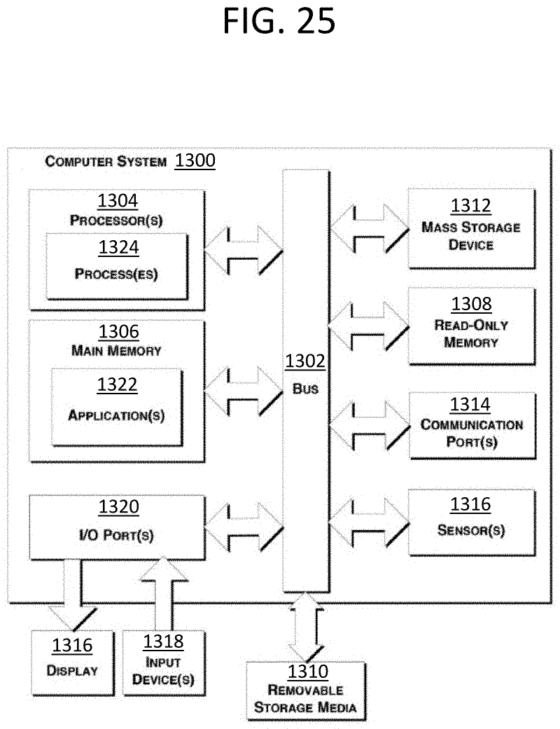

FIG. 25 is a schematic diagram of a computer system 1300 upon which embodiments of the present disclosure may be implemented and carried out.

According to the present example, the computer system 1300 includes a bus 1302 (i.e., interconnect), one or more processors 1304, a main memory 1306, read-only memory 1308, removable storage media 1310, mass storage 1312, and one or more communications ports 1314. Communication port(s) 1314 may be connected to one or more networks (not shown) by way of which the computer system 1300 may receive and/or transmit data.

As used herein, a “processor” means one or more microprocessors, central processing Units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1304 can be any known processor, such as, but not limited to, an Intel® Itanium® or Itanium 2® processor(s), AMD® Opteron® or Athlon MP® processor(s), or Motorola® lines of processors, and the like. Communications port(s) 1314 can be any of an Ethernet port, a Gigabit port using copper or fiber, or a USB port, and the like. Communications port(s) 1314 may be chosen depending on a network such as a Local Area Network (LAN), a Wide Area Network (WAN), or any network to which the computer system 1300 connects. The computer system 1300 may be in communication with peripheral devices (e.g., display screen 1316, input device(s) 1318) via Input/Output (I/O) port 720.

Main memory 1306 can be Random Access Memory (RAM), or any other dynamic storage device(s) commonly known in the art. Read-only memory (ROM) 1308 can be any static storage device(s) such as Programmable Read-Only Memory (PROM) chips for storing static information such as instructions for processor(s) 1304. Mass storage 1312 can be used to store information and instructions. For example, hard disk drives, an optical disc, an array of disks such as Redundant Array of Independent Disks (RAID), or any other mass storage devices may be used.

Bus 1302 communicatively couples processor(s) 1304 with the other memory, storage and communications blocks. Bus 1302 can be a PCI/PCI-X, SCSI, a Universal Serial Bus (USB) based system bus (or other) depending on the storage devices used, and the like. Removable storage media 1310 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1306 is encoded with application(s) 1322 that support(s) the functionality as discussed herein (the application(s) 1322 may be an application(s) that provides some or all of the functionality of the services/mechanisms described herein). Application(s) 1322 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1304 accesses main memory 1306 via the use of bus 1302 in order to launch, run, execute, interpret or otherwise perform the logic instructions of the application(s) 1322. Execution of application(s) 1322 produces processing functionality of the service related to the application(s). In other words, the process(es) 1324 represent one or more portions of the application(s) 1322 performing within or upon the processor(s) 1304 in the computer system 1300.

It should be noted that, in addition to the process(es) 1324 that carries (carry) out operations as discussed herein, other embodiments herein include the application 1322 itself (i.e., the Un-executed or non-performing logic instructions and/or data). The application 1322 may be stored on a computer readable medium (e.g., a repository) such as a disk or in an optical medium.

According to other embodiments, the application 1322 can also be stored in a memory type system such as in firmware, read only memory (ROM), or, as in this example, as executable code within the main memory 1306 (e.g., within Random Access Memory or RAM). For example, application(s) 1322 may also be stored in removable storage media 1310, read-only memory 1308, and/or mass storage device 1312.

Those skilled in the art will understand that the computer system 1300 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and Understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

A person of ordinary skill in the art will understand, that any method described above or below and/or claimed and described as a sequence of steps is not restrictive in the sense of the order of steps.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention is unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A detection system comprising:
a mobile housing;
an integrated mobile device contained within the mobile housing;
a millimeter wave imaging system contained within the mobile housing and that provides millimeter wave imaging first data;
a thermal imaging system contained within the mobile housing and that provides thermal imaging second data; and
a video capturing system contained within the mobile housing and that provides visible light video third data; and
a controller adapted to overlay the millimeter wave imaging data and the thermal imaging data with the visible light video to form a live video steam;
wherein the millimeter wave imaging data, the thermal imaging data and the visible light video data are combined into a live video stream and displayed on the integrated mobile device.

2. (canceled)

3. The system of claim 2 wherein the millimeter wave imaging data, the thermal imaging data and the video data each include at least some imaging data of the same object.

4. The system of claim 1 wherein the live video stream includes information regarding a concealed object.

5. The system of claim 4 wherein the concealed object is selected from the group: a gun, a knife and an explosive.

6. The system of claim 1 wherein the video capturing system is included in the integrated mobile device.

7. The system of claim 1 wherein the integrated mobile device includes a display screen and the first data, the second data, the third data and/or the fourth data are displayed on the display screen.

8. The system of claim 1 further comprising an acoustic detection system that provides acoustically detected data.

9. The system of claim 8 wherein the acoustically detected data includes the identification of an acoustic event.

10. The system of claim 9 wherein the acoustic event is selected from the group: a gunshot, a bomb blast and a scream.

11. The system of claim 1 wherein the integrated mobile device includes an interface, and wherein the fourth data is displayed on the interface.

12. The system of claim 1 further comprising a facial recognition system that provides facial recognition data.

13. A method of detecting a concealed object, the method comprising:
(A) providing an integrated mobile device;
(B) providing a millimeter wave imaging system;
(C) providing a thermal imaging system;
(D) providing a visible light video capturing system;
(E) housing the integrated mobile device, the millimeter wave imaging system, the thermal imaging system and the visible light video capturing system into a mobile housing;
(F) using the millimeter wave imaging system to collect millimeter wave imaging data;
(G) using the thermal imaging system to collect thermal imaging data;
(H) using the visible light video capturing system to collect visible light video data;
(I) combining the millimeter wave imaging data, the thermal imaging data and the visible light video data into a live video stream; and
(J) displaying the live video stream on the integrated mobile device.

14. The method of claim 13 wherein the visible light video capturing system is included in the integrated mobile device.

15. The method of claim 13 wherein the first imaging data, the second data and the third imaging data each include at least some imaging data of the same object.

16. The method of claim 13 wherein the single live video stream includes information regarding the concealed object.

17. The method of claim 13 wherein the single live video stream highlights the concealed object.

18. The method of claim 13 wherein the concealed object is selected from the group: a gun, a knife and an explosive.
